(19) United States
(12) Patent Application Publication
(10) Pub. No.: US 2014/0047719 A1
(43) Pub. Date: Feb. 20, 2014

(54) HEDGE TRIMMER

(71) Applicant: HITACHI KOKI CO., LTD., Tokyo (JP)

(72) Inventors: Yasutaka SHIMIZU, Hitachinaka (JP); Shogo SHIBATA, Hitachinaka (JP); Seiichi KODATO, Hitachinaka (JP); Kouji SAGAWA, Hitachinaka (JP); Shingo KOSUGI, Hitachinaka (JP)

(73) Assignee: HITACHI KOKI CO., LTD., Tokyo (JP)

(21) Appl. No.: 13/971,510

(22) Filed: Aug. 20, 2013

(30) Foreign Application Priority Data
Aug. 20, 2012 (JP) 2012-181844

(51) Int. Cl. A01G 3/053

(52) U.S. Cl. CPC A01G 3/053
USPC 30/216

(57) ABSTRACT

In a hedge trimmer, a main body is configured of: a main body front portion on a front side (a side on which the cutting blade protrudes); a main body rear portion on a rear side; and a supporting portion for connecting them on a lower side. One end of a main handle and the other end of the same are connected to an upper portion of the main body front portion on the rear end side and an upper portion of the main body rear portion on the front end side. The main handle has a linear shape in parallel to a longitudinal direction of a cutting blade. In this configuration, the main handle is set in substantially parallel to the supporting portion, and a grip space is formed between the main handle and the supporting portion.

### CROSS-REFERENCE TO RELATED APPLICATION

The present application claims priority from Japanese Patent Application No. 2012-181844 filed on Aug. 20, 2012, the content of which is hereby incorporated by reference into this application.

### TECHNICAL FIELD OF THE INVENTION

The present invention relates to a hedge trimmer used for trimming branches and leaves of a hedge or others in which a cutting blade is reciprocated by a motor.

### BACKGROUND OF THE INVENTION

A hedge trimmer is used to cut off branches and leaves in, for example, desirably shaping a hedge or others by an elongated cutting blade which linearly reciprocates. This cutting work is usually performed so that a worker holds the hedge trimmer with his/her both hands and moves the cutting blade along the shape of the hedge. Therefore, the hedge trimmer has a size and a weight suitable enough to be portable by the worker. When a motor is used as a driving source for the cutting blade, it is particularly preferred to use a battery as a power supply which can be used even in a place where connection to a commercial power supply is difficult, and besides, which can be used a plurality of times by recharging. The battery is used in a form of a battery pack attached to a main body of the hedge trimmer.

For example, when the cutting work for a wooden board is performed, the cutting work is performed in many cases by setting a cutting blade of a cutter (circular saw, etc.) in a vertical direction in a state that a cutting cross-sectional surface of the wooden board is horizontally maintained and abutting the cutting blade in vertical to the cutting cross-sectional surface of the wooden board. Meanwhile, when the trimming work for the hedge or others is performed by using the hedge trimmer, a worker 200 sets a cutting blade 101 of a hedge trimmer 100 at various angles in various places so as to cut branches and leaves off in a hedge 300 as illustrated in, for example, FIGS. 10A and 10B.

Therefore, the hedge trimmer is configured so that the worker 200 can hold the whole hedge trimmer in the state that the cutting blade is set at various angles. Such a specific configuration of the hedge trimmer is described in, for example, FIG. 1 of Japanese Patent Application Laid-Open Publication No. 2009-219425 (Patent Document 1) or others. Generally, two handles are mounted on a main body from which the cutting blade 101 extends out. For example, in an example of FIG. 10, the worker 200 performs the trimming work while gripping a sub-handle 102 of the hedge trimmer 100 with one hand (left hand in the drawing) and gripping a main handle 103 with the other hand (right hand in the drawing).

In this hedge trimmer 100, the elongated cutting blade 101 is protruded forward from the main body 104 in which a motor, a gear box, and others are embedded, and the cutting blade 101 reciprocates longitudinally (in a front-to-rear direction) with using the motor embedded in the main body 104 as a driving source. The sub-handle 102 and the main handle 103 are made of, for example, plastic, whose surface is appropriately subjected to antislip treatment in order to allow the worker to firmly grip them. Both ends of the sub-handle 102 are fixed to the main body 104 so that the main body 104 has a reversed U shape which perpendicularly bridges over the longitudinal direction of the cutting blade 101. Also, the sub-handle 102 is configured so as to be mounted in front of the main body 104 (on the side closer to the cutting blade 101), and can be gripped by the worker from above in FIG. 10A. Meanwhile, the main handle 103 has a shape almost along the cutting blade 101, and is mounted on the rear of the main body 104. Although the main body 104 is heavy because the motor, the gear for driving the cutting blade 101, and others are embedded in the main body 104, the worker 200 can perform the trimming work as illustrated in FIGS. 10A and 10B by holding the hedge trimmer 100 with using the sub-handle 102 and the main handle 103.

At this time, a main switch for controlling turning on/off of the motor is provided on a lower surface of the main handle 103 and on a lower surface of an upper part of the sub-handle 102 illustrated in FIG. 10A. In this manner, it is set that the motor is driven to move the cutting blade 101 only when the worker grips each of the main handle 103 and the sub-handle 102 and presses each of the main switches. Therefore, this hedge trimmer 100 can be used safely.

Further, when a speed of the reciprocation movement of the cutting blade 101 is variable so that an optimal speed can be set depending on an object to be cut, the trimming work can be performed to be easier and more accurate. Therefore, it is preferred to adopt a configuration in which the plurality of speeds can be selected and set. In this case, the configuration can be made so that, for example, a single speed change switch is provided, and the speed is changed step by step for each press of this speed change switch by the worker. By mounting this speed change switch at a position, for example, where the switch can be operated with a finger of the hand gripping the main handle 103, the worker can operate the speed change switch with the finger while gripping the main handle 103. Therefore, the trimming work can be performed to be more appropriate and easier.

By such a configuration, a hedge trimmer that is easy to handle for the worker can be obtained.

### SUMMARY OF THE INVENTION

By the above-described configuration, the worker can perform the trimming work while setting the direction of the cutting blade 101 in various directions. However, from a viewpoint of more efficient work, it is preferred that the operation for changing this direction is performed in a state that the worker grips the main handle 103 and the sub-handle 102 as the cutting blade 101 is moving. In this point, the hedge trimmer 100 having the configuration of FIGS. 10A and 10B is not favorable for workability.

In the hedge trimmer 100 having the configuration of FIGS. 10A and 10B, description is made as follows in a case that, for example, an operation for rotating the hedge trimmer 100 around the longitudinal direction of the cutting blade 101 as a rotation axis is performed while gripping the sub-handle 102 with one hand and gripping the main handle 103 with the other hand. This operation corresponds to an operation performed when a state of FIG. 10A is shifted to a state of FIG. 10B.

When the hedge trimmer 100 is used in the state of FIG. 10A, the worker grips the sub-handle 102 with one hand and the main handle 103 with the other hand from above in FIG. 10A. In order to shift this state to the state of FIG. 10B, an operation for rotating the whole hedge trimmer 100 by 90 degrees around the main handle 103 as a rotation axis is required while the worker grips the main handle 103 with the other hand but changes a grip position on the sub-handle 102 with one hand.

Here, although the main body 104 is heavy as described above, the worker 200 can perform the above-described operation using the sub-handle 102 and the main handle 103 fixed to the body 104. However, practically, the battery pack used as the power supply is attached to the main body 104. The larger the capacity so as to have the longer continuous use time is, the heavier this battery pack is. Since it is required that the battery pack is easily attached to the main body 104, the battery pack is usually attached to an end of the main body 104. Therefore, inertia moment in the rotation of the whole hedge trimmer 100 around the main handle 103 as the rotation axis is increased. That is, strong arm force is required for the operation of rotating the hedge trimmer 100 around the main handle 103 as the rotation axis while the worker grips the main handle 103, and therefore, this operation is practically not easy.

Therefore, in order to practically shift the state of FIG. 10A to the state of FIG. 10B, in many cases, the worker gets the hands off from the main handle 103 and the sub-handle 102 once, turns off the movement of the hedge trimmer 100, and switches to hold the main handle 103 and the sub-handle 102, and then, moves the hedge trimmer 100. Therefore, in handling the hedge trimmer 100, it is practically difficult to perform the operation for changing the direction of the cutting blade 101 while moving the cutting blade 101. Also, it is desired that the main handle 103 is small in a diameter so as to be easily gripped by the worker and easily rotate the whole hedge trimmer 100. However, on the other hand, there is a problem that the end of the main body 104 keeps strength for holding the high-capacity battery pack.

As described above, it is difficult to obtain the hedge trimmer that allows the worker to easily perform the trimming work while changing the direction of the cutting blade.

The present invention has been made in consideration of such problems, and a preferred aim of the present invention is to provide the invention for solving the above-described problems.

In order to solve the above-described problems, the present invention is configured as follows. A hedge trimmer according to an embodiment includes: a main body in which a motor is embedded; a cutting blade which is reciprocated by the motor in a longitudinal direction so as to protrude from a front end of the main body; a battery pack which is mounted on the main body and which is functioned as a power supply for driving the motor; a sub-handle which has a reversed U shape so as to bridge over the main body in perpendicular to the longitudinal direction of the cutting blade and whose both ends are connected to the main body; and a main handle which is connected to the main body on the side closer to the rear end of the main body than the sub-handle so as to extend to form a grip space in the longitudinal direction between the main handle and the main body. The main body is formed of: a main body front portion which is configured to include the front end and to which the sub-handle is connected; a main body rear portion which is configured to include the rear end and on which the battery pack is mounted; and a supporting portion which connects the main body front portion and the main body rear portion on a lower side. A center axis of the main handle is formed in a straight line shape in parallel to the longitudinal direction, and one end and the other end of the main handle are connected to a rear end side of the main body front portion and a front end side of the main body rear portion, respectively, so that the grip space is formed between the main handle and the supporting portion, and the battery pack is mounted on the rear end side of the main body rear portion.

Since the present invention is configured as described above, a hedge trimmer allowing a worker to easily perform trimming work while changing a direction of a cutting blade can be obtained.

### BRIEF DESCRIPTIONS OF THE DRAWINGS

FIG. 1 is a perspective view of a hedge trimmer according to an embodiment of the present invention;

FIG. 2A and FIG. 2B are a top view of the hedge trimmer according to the embodiment of the present invention and an enlarged view of the top view;

FIG. 3 is a side view of the hedge trimmer according to the embodiment of the present invention;

FIGS. 4A and 4B are enlarged side views in vicinity of a main handle of the hedge trimmer according to the embodiment of the present invention (a state with attaching a battery pack: 4A, and a state without attaching the battery pack: 4B);

FIG. 5 is a downward view of the hedge trimmer according to the embodiment of the present invention, viewed from a cross-sectional surface in an A-A direction;

FIGS. 6A and 6B are a forward view of the hedge trimmer according to the embodiment of the present invention, viewed from a cross-sectional surface in a B-B direction, and a forward view thereof, viewed from a cross-sectional surface in a C-C direction, respectively;

FIG. 7 is an up-to-down directional cross-sectional view including a center axis of the main handle of the hedge trimmer according to the embodiment of the present invention;

FIGS. 8A and 8B are views schematically illustrating movement of a main switch mounted on the main handle used in the hedge trimmer according to the embodiment of the present;

FIGS. 9A to 9C are a front view in periphery of a sub-handle of the hedge trimmer according to the embodiment of the present invention, a side view thereof, and a top view thereof, respectively; and

FIGS. 10A and 10B are views schematically illustrating an aspect when trimming work for a hedge is performed by using a hedge trimmer.

### DESCRIPTIONS OF THE PREFERRED EMBODIMENTS

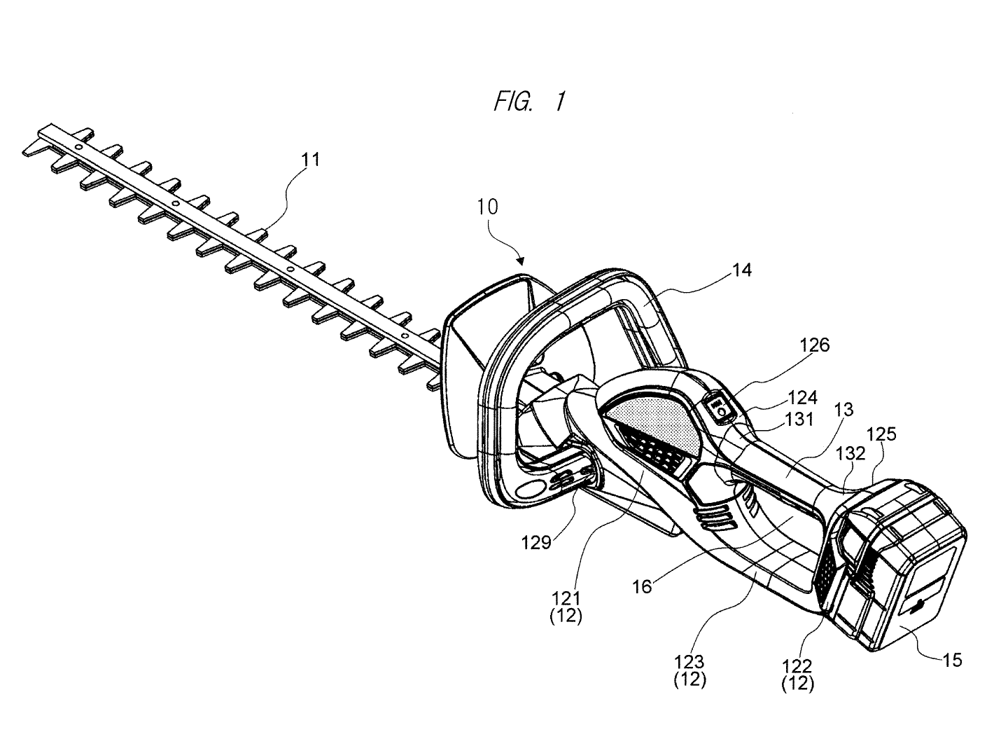

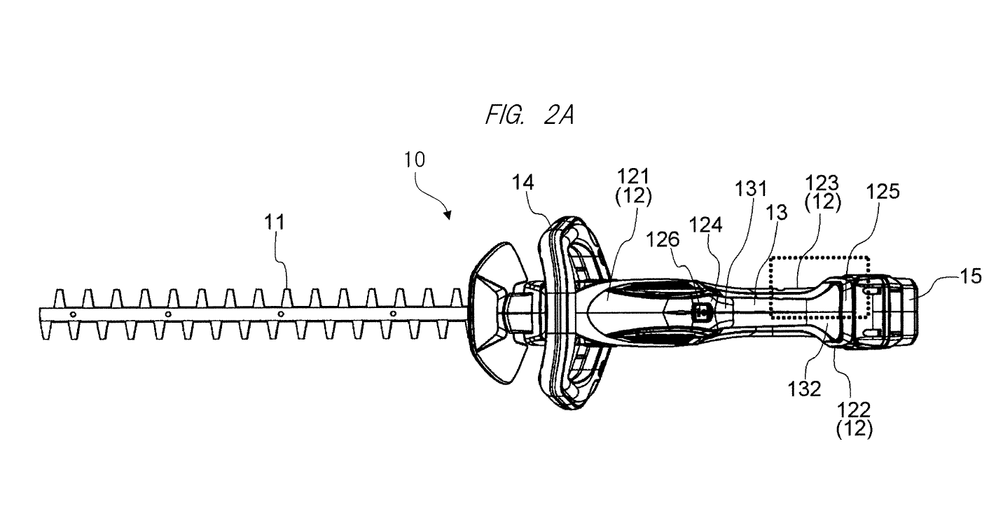

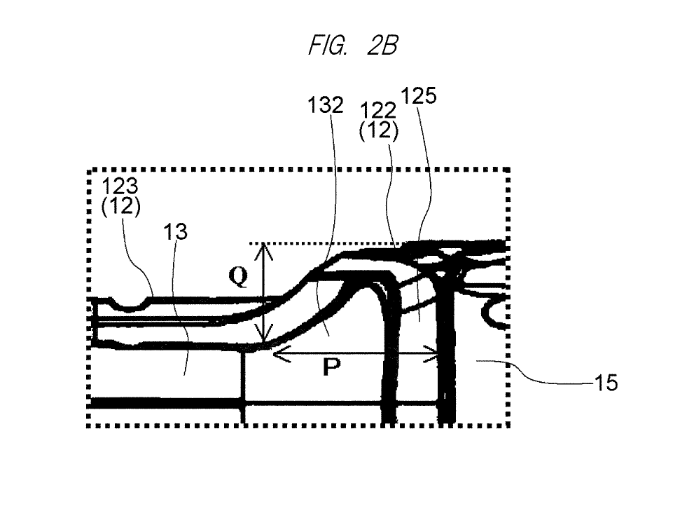

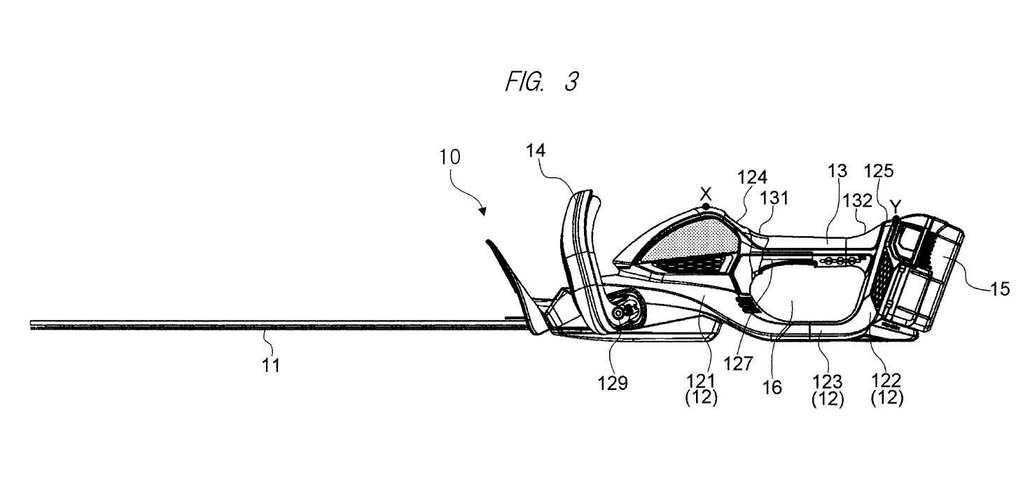

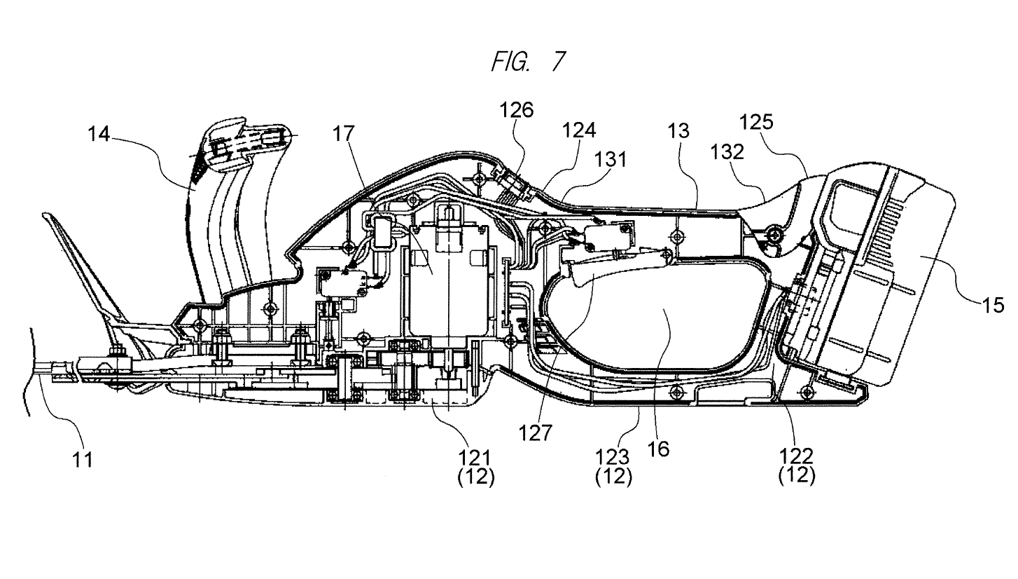

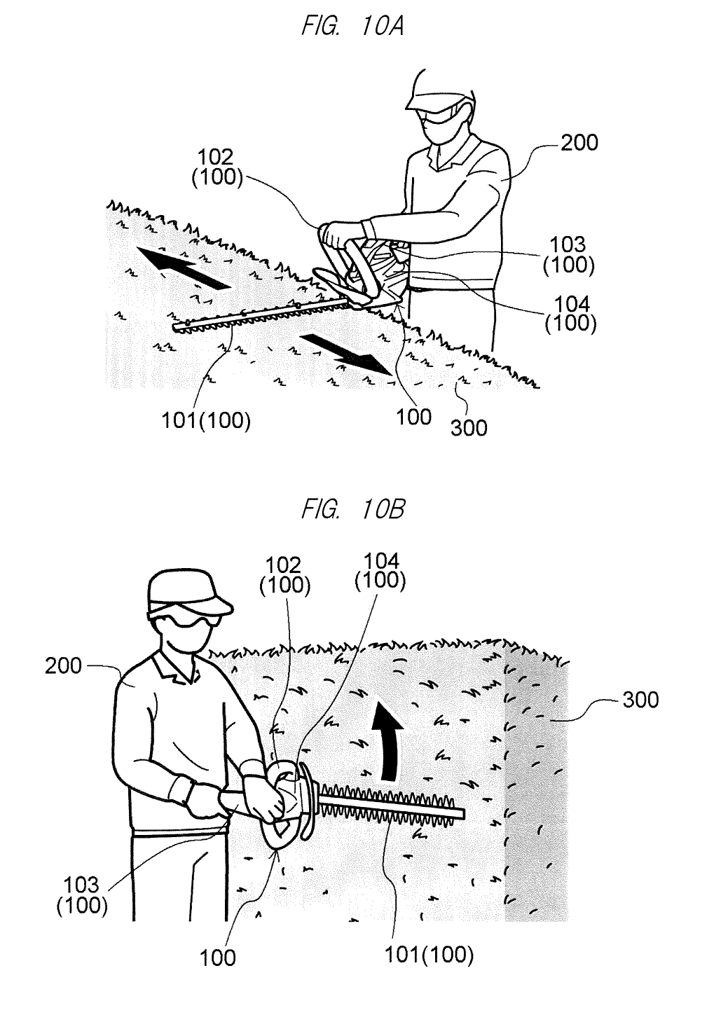

A configuration of a hedge trimmer according to an embodiment of the present invention will be described. FIG. 1 is a perspective view illustrating the configuration of this hedge trimmer 10, FIG. 2A is a top view of the hedge trimmer 10, FIG. 2B is an enlarged view of a part of the hedge trimmer 10 encircled with a dotted line, and FIG. 3 is a side view of the hedge trimmer 10. Hereinafter, a left side and a right side in FIGS. 2A to 3 are defined as a front side and a rear side, respectively, and an upside and a downside in FIG. 3 are defined as an upper side and a lower side, respectively. Here, the hedge trimmer 10 is configured of a cutting blade 11, a main body 12, a main handle 13, a sub-handle 14, and a battery pack 15. The cutting (trimming) work is performed by reciprocating the cutting blade 11 protruded forward from the front end of the main body 12 in the longitudinal direction by using a motor 17 (see FIG. 7) embedded in the main body 12 as a driving source. The battery pack 15 serves as a power supply at this time. A worker can perform the work by gripping the main handle 13 and the sub-handle 14. These respects are the same as those of a conventional hedge trimmer 100 illustrated in FIGS. 10A and 10B.

Here, in the above-described hedge trimmer 10, the main body 12 is configured of a main body front portion 121 on the front side (on which the cutting blade 11 protrudes), a main body rear portion 122 on the rear side, and a supporting portion 123 for connecting them on a lower side.

The main body front portion 121 includes the motor 17, a gear box for converting the rotation movement of the motor 17 into the reciprocation movement, and others embedded therein, and is configured so that the cutting blade 11 protrudes from the front end of the main body front portion. Note that a cutting blade cover for covering an upper surface side of the cutting blade 11 which is fixed to the main body front portion 121 is also mounted on the upper surface side of the cutting blade 11.

The battery pack 15 is attached to the rear end side of the main body rear portion 122. Therefore, the main body rear portion 122 and the battery pack 15 are integrated together in the usage. As the battery pack 15, a battery pack with a nominal voltage of 14.4 V and a nominal capacity of 1.5 Ah/cell (about 310 g) or a battery pack with a nominal voltage of 18 V and a nominal capacity of 1.5 Ah/cell (about 368 g) is generally used in order to extend the working time whereas, for example, desirably a battery pack with a nominal voltage ranging from 20 V to 36 V is used in order to improve the working time. In a nominal voltage of 36 V, a nominal capacity of 2.0 Ah/cell has a weight of 750 g which is a larger weight than that of a battery pack generally used.

A lower part of the main body front portion 121 and a lower part of the main body rear portion 122 are connected to each other by the supporting portion 123 having a substantially linear shape in parallel to the longitudinal direction of the cutting blade 11, so that they are integrated together. Here, the supporting portion 123 is lighter than the main body front portion 121 in which the motor 17 and others are embedded and the main body rear portion 122 to which the battery pack 15 attached. However, in the usage, the heavy battery pack 15 is attached to the main body rear portion 122, and this weight is not ignorable when the worker holds the hedge trimmer 10. And, a cable through which various signals and a drive current for the motor 17 flow is formed between the main body front portion 121 and the main body rear portion 122, and the cable is configured so as to pass through inside of the supporting portion 123 and the main handle 13.

The hedge trimmer 10 has features in particularly a configuration of the main handle 13 and periphery thereof and a configuration of the sub-handle 14 and periphery thereof. By these features, the operation of rotating the hedge trimmer 10 can be easily performed even when the heavy battery pack 15 is attached. These features will be sequentially described below.

(Main Handle)

First, the configuration of the main handle 13 and periphery thereof will be described. One end (front end) and the other end (rear end) of the main handle 13 are connected to an upper part of a rear end side of the main body front portion 121 and an upper part of a front end side of the main body rear portion 122, respectively. That is, the main body front portion 121 is arranged on the front side of the main handle 13, and the main body rear portion 122 is arranged on the rear side of the main handle 13. And, the main handle 13 has the linear shape in parallel to the longitudinal direction of the cutting blade 11. In this configuration, the main handle 13 and the supporting portion 123 are substantially in parallel to each other, so that a grip space 16 is formed between the main handle 13 and the supporting portion 123. Here, note that, for example, the main handle 13 having the linear shape means that a center axis of the main handle 13 is linear, and the substantially parallel state of the main handle 13 with respect to the supporting portion 123 means that the center axis is substantially in parallel to a center axis of the supporting portion 123. As illustrated in FIG. 3, the supporting portion 123 is provided along an extension line of a bottom surface of the main body front portion 121 so as to form a substantially single plane surface on a bottom side of the hedge trimmer 10 together with the main body front portion 121 and the main body rear portion 122. This achieves the favorable workability when the hedge trimmer is handled along an upper portion of an object to be cut (such as the hedge). Also, the bottom surface of the supporting portion 123 is formed so as to extend to the bottom surface of the battery pack 15, and therefore, plays a role of a guard for covering the bottom surface of the battery pack 15.

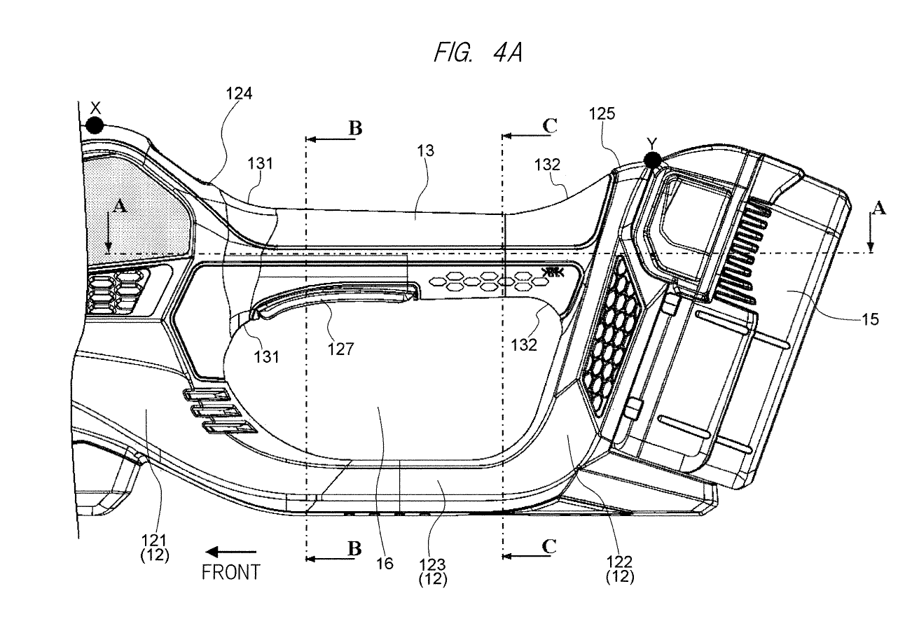

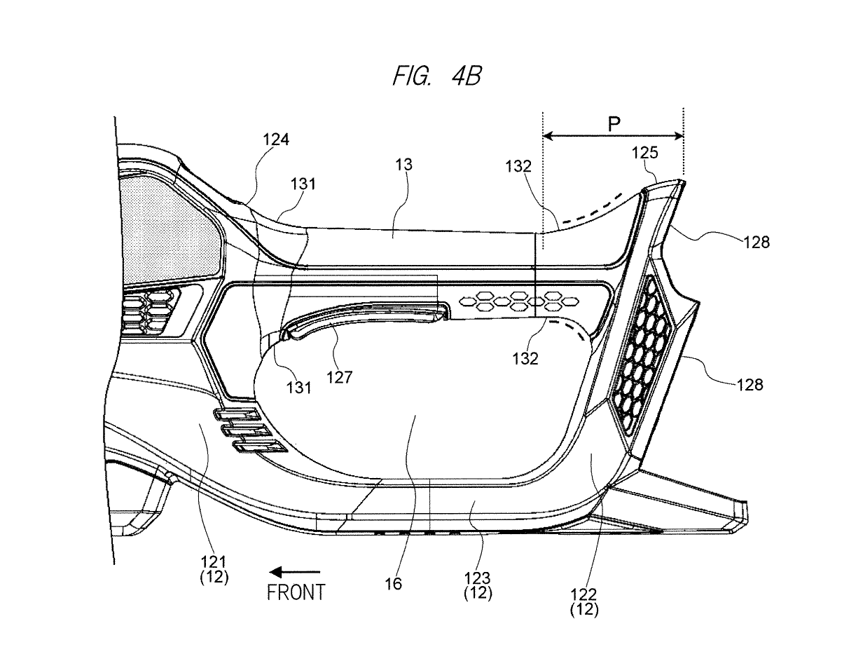

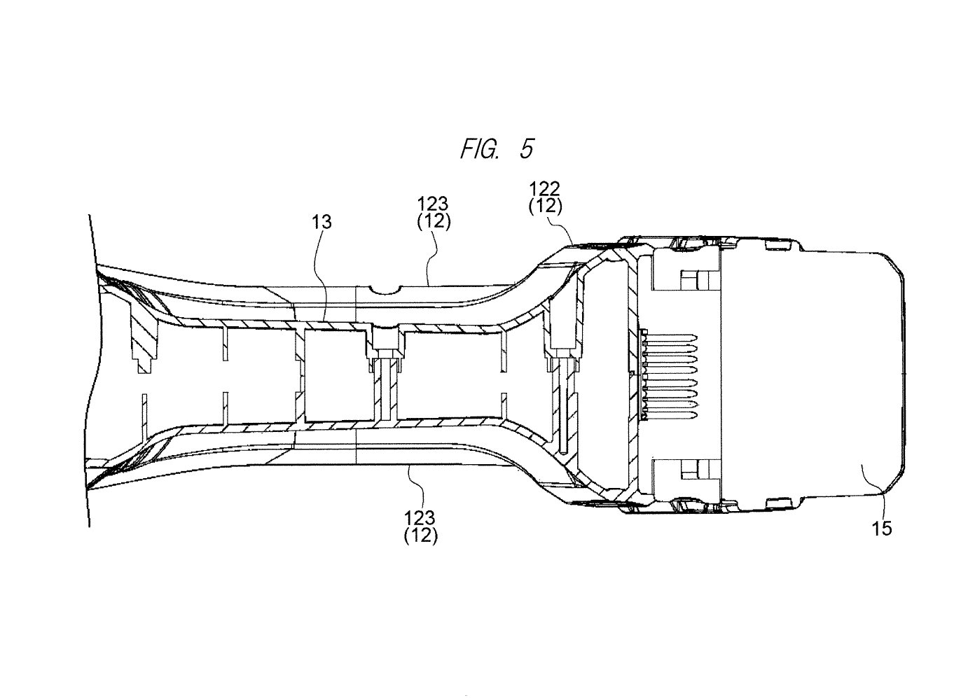

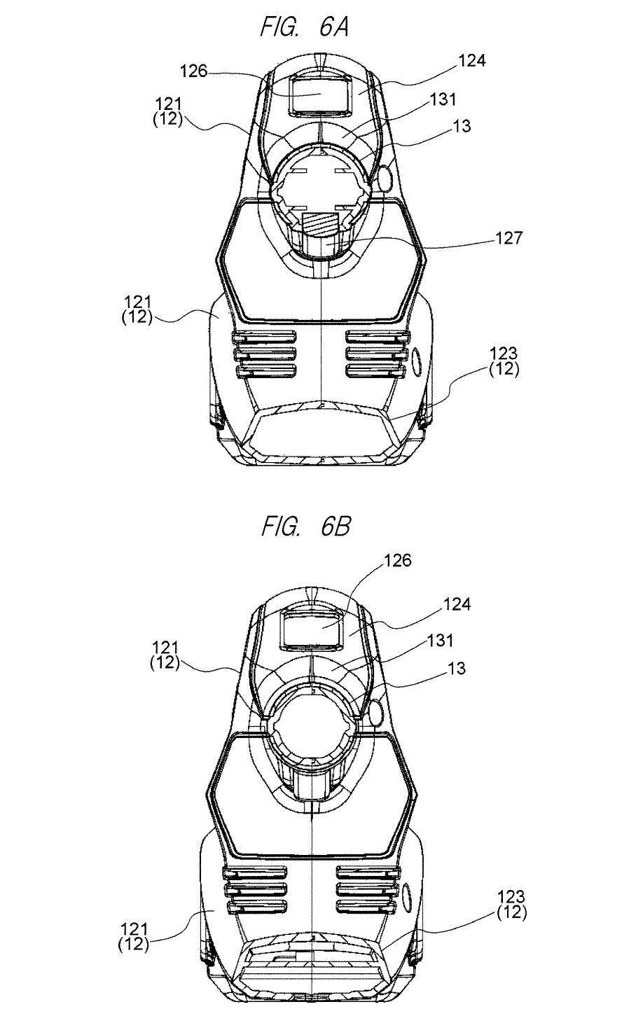

FIGS. 4A and 4B are enlarged side views in periphery of the main handle 13 of the hedge trimmer 10, and FIG. 4A illustrates a state with mounting the battery pack 15 and FIG. 4B illustrates a state without mounting the battery pack 15, respectively. FIG. 5 is a downward view of FIGS. 4A and 4B, viewed from a cross-sectional surface in an A-A direction, FIG. 6A is a forward view of FIGS. 4A and 4B, viewed from a cross-sectional surface in a B-B direction, and FIG. 6B forward view of FIGS. 4A and 4B, viewed from a cross-sectional surface in a C-C direction. FIG. 5 illustrates a cross-sectional surface of the main handle 13 along the center axis, and FIGS. 6A and 6B illustrate cross-sectional surfaces at different portions in the front-to-rear direction (FIG. 6A: the front side, FIG. 6B: the rear side).

Also, FIG. 7 is a cross-sectional view in the front-to-rear direction of the structure in the periphery of the main body 12 including the center axis of the main handle 13.

As illustrated in FIGS. 4, 5, 6A, 6B, and 7, a shape of a cross-sectional surface perpendicular to the center axis of the main handle 13 is a substantially circular shape, and an outer diameter of the shape is gradually narrowed rearward from the front side (the side on the cutting blade 11). The outer diameter has such an appropriate size as capable of being gripped by the worker at any portion. However, as illustrated in FIGS. 1 to 4, in front of the main handle 13, a front tapered portion 131 which is a portion widened frontward by further gradually increasing a taper angle is provided. Similarly, at the rear thereof, a rear tapered portion 132 which is a portion gradually widened rearward on the contrary of the above-described shape which is narrowed rearward is provided. In the shape of the rear tapered portion 132 which is widened toward the main body rear portion 122, a side-surface shape thereof has a larger curvature radius on an upper side and a smaller curvature radius on a lower side as indicated by a broken line in FIG. 4B.

At this time, as illustrated in FIG. 2B, it is assumed that a distance in the front-to-rear direction between the narrowest portion of the main handle 13 at the rear and the attachment portion for mounting the battery pack 15 on the main body rear portion 122 is a distance “P”. Also, it is assumed that a distance in a right-to-left direction between the narrowest portion and the most protruding portion of the battery pack 15 in the right-to-left direction (the up-to-down direction in FIG. 2) is a distance “Q”. Here, these distances are set so that a relation of “P Q” is satisfied. Here, according to the research results made from 1995 to 1999 by the National Institute of Technology and Evaluation, the National Institute of Bioscience and Human Technology in the Agency of Industrial Science and Technology in the Ministry of International Trade and Industry (The current Independent Administrative Institution of National Institute of Advanced Industrial Science and Technology), it is desired from a human engineering viewpoint that the main handle 13 has a peripheral length of 94 mm to 157 mm. In the present embodiment, the peripheral length of the narrowest portion of the main handle 13 on the battery-pack side is determined to be about 105 mm. Also, the peripheral length of a portion for a main switch 127 on the main handle 13 is determined to be about 120 mm.

As illustrated in FIG. 4A, both of atop portion X of the main body front portion 121 and a top portion Y of the main body rear portion 122 are set to be higher than the main handle 13. Further, in the front of the main handle 13, an upper surface between the top portion X of the main body front portion 121 and one end of the main handle 13 is formed into a main body front sloped portion 124 whose height changes gradually. Similarly, at the rear of the main handle 13, an upper surface between the top portion Y of the main body rear portion 122 and the other end of the main handle 13 is formed into a main body rear sloped portion 125 whose height changes gradually. Also, as illustrated in FIGS. 1 and 2, a speed change switch 126 is mounted on the main body front sloped portion 124. The speed change switch 126 is set so that the motion speed of the cutting blade 11 changes step by step every time the worker presses the switch 126. That is, every time the worker presses the speed change switch 126, the speed of reciprocation movement of the cutting blade 11 is controlled.

As illustrated in FIG. 7, the motor 17 is embedded inside the main body front portion 121, and reciprocates the cutting blade 11 in the longitudinal direction via a plurality of gears in the lower portion of the motor 17. Since such components are provided, the main body front portion 121 is heavier than each of the main body rear portion 122, the supporting portion 123, the main handle 13, and the sub-handle 14.

Also, as illustrated in FIGS. 3 to 4B, a main switch 127 is mounted on a front underside of the main handle 13 (the side on which the grip space 16 is formed). It is set that the motor 17 is turned on so as to reciprocate the cutting blade 11 by pressing the main switch 127 while the worker grips the main handle 13 (pressing it toward the center axis side of the main handle 13). However, practically, the main switch is mounted also on the sub-handle 14, and it is set for safety that the motor 17 is turned on only when both of the main switches are pressed simultaneously.

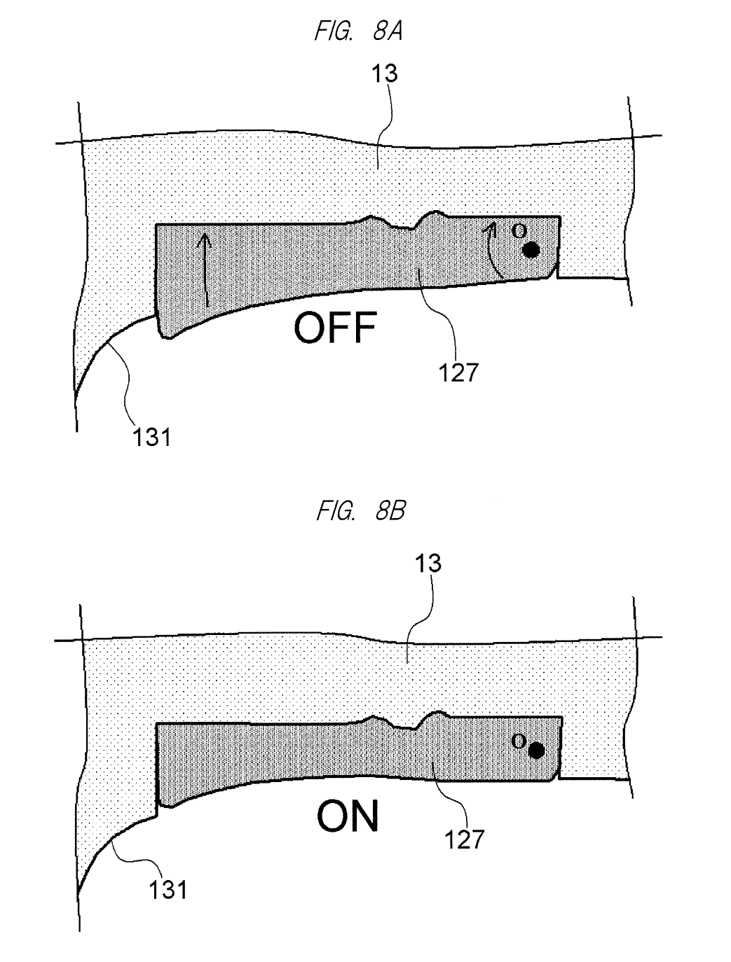

FIGS. 8A and 8B schematically illustrate the configuration of the periphery of the main switch 127 in FIG. 4 and the movement of the main switch 127 to be enlarged. Here, FIG. 8A illustrates a state in which the main switch 127 (or the motor 17) is turned off, and FIG. 8B illustrates a state in which the main switch 127 is turned on. The main switch 127 has such a setting as rotating around a pivot axis O set on the rear side of the main switch 127, that is, on the other end side of the main handle 13. However, in a state without application of external force, the main switch 127 is urged counterclockwise in FIGS. 4A and 4B around the pivot axis O by the force of a spring, and therefore, the motor 17 is turned off in the state without application of external force.

By the upward pressing (pressing toward the center axis side of the main handle 13) from the state of FIG. 8A, the state is changed to the state of FIG. 8B, and the motor 17 is turned on. In the off-state (FIG. 8A), a level difference is formed between the surface of the main handle 13 and the lower surface of the main switch 127 in the left side of FIG. 4A. On the other hand, in the on-state (FIG. 8B), this level difference disappears.

Also, as illustrated in FIGS. 4A and 4B, the battery pack 15 is mounted on a battery-pack attachment surface 128 on a plane surface formed on the rear end side of the main body rear portion 122. Therefore, a bottom surface (one surface) of the battery pack 15 is a plane surface integrated with the battery-pack attachment surface 128. The battery-pack attachment surface 128 is formed on the main body rear portion 122 so as to have an angle tilted from an angle perpendicular to the center axis of the main handle 13 toward the rear end side.

By the above-described configuration, the worker can easily perform the operation of rotating the whole hedge trimmer 10 around the main handle 13 as the rotation axis while gripping the main handle 13 as described below. This action will be explained in the following description.

First, in the hedge trimmer 100 illustrated in FIG. 10 as the conventional technique, when a heavy battery pack is attached to the main body 104, the worker can easily hold the hedge trimmer 100 while gripping the main handle 103 from above in FIG. 10A. However, the inertia moment in the periphery of the main handle 103 is increased by the heavy battery pack, and therefore, the worker needs strong arm force in order to rotate the hedge trimmer 100 around the main handle 103 as the rotation axis.

Further, it is easy for the worker 200 to hold the hedge trimmer 100 from above with both hands as illustrated in FIG. 10A. However, depending on the positional relation between the worker 200 and the hedge trimmer 100, even the operation of holding the hedge trimmer 100 is not easy. For example, when the worker 200 holds the hedge trimmer 100 at a higher position than the worker's shoulder, a part of the worker's hand holding the main handle 103 is in contact with a portion other than the main handle 103, and therefore, it is difficult to hold the hedge trimmer 100 in some cases.

On the other hand, in the above-described hedge trimmer 10, the battery pack 15 is mounted close to the center axis of the main handle 13, and therefore, it is easy to rotate the hedge trimmer 10. At this time, this operation is particularly easy because of the main handle 13 having the linearly shape and the substantially circular cross-sectional shape. In addition, at this time, for example, when the worker desires to rotate the hedge trimmer 10, this operation is particularly easy by shifting the gripping portion of the main handle 13 rearward little bit because of the outer diameter of the main handle 13 which is gradually narrowed rearward from the front side.

However, when the battery pack 15 is mounted on the rear side in FIGS. 4A and 4B, the worker's hand gripping the main handle 13 interfere with the battery pack 15 in some cases depending on the positional relation between the worker and the hedge trimmer 10. Therefore, on the side on which the hand is placed (the upside of the main handle 13 in FIG. 4), in order to avoid the interference of the hand with the battery pack 15, it is set that the battery-pack attachment surface 128 has the angle tilted from the angle perpendicular to the center axis of the main handle 13 toward the rear end so as to separate the upper end of the battery pack away from the main handle 13. In this manner, on the side on which the hand gripping the main handle 13 is placed, the battery pack 15 can be arranged on the rear end side so that the interference of the hand with the battery pack 15 is difficult to cause.

Also, the main handle 13 is also configured so that, when the worker grips any part of the main handle 13 from any posture, apart of the worker's hand gripping this is not come in contact with other parts. For example, when the worker grips the main handle 13 at a position higher than the worker's shoulder or grips it with stretching the worker's arm, the worker can put the antithenar (a thick eminence area closer to the wrist than the little finger) on the rear tapered portion 132 without the contact of the hand with the battery pack 15. Accordingly, as indicated by broken lines in FIG. 4B, the curvature radius of the upper side of the rear tapered portion 132 which is the antithenar-putting side is larger than the curvature radius of the lower side of the rear tapered portion 132. Similarly, the front tapered portion 131 is provided so that the worker easily grips the whole main handle 13. In this manner, the interference of the hand gripping the main handle 13 with a raised part of the main body front portion 121 in which the motor 17 is provided is suppressed.

Further, when the battery pack has the large capacity and the large size, the battery pack 15 and the following main body rear portion 122 protrude particularly in the right-to-left direction at the rear of the main handle 13 as illustrated in FIGS. 2A and 2B. By setting the relation of “P Q” in FIG. 2B, it is suppressed that the hand gripping the main handle 13 interferes with the protruding portions of the battery pack 15 and others in the right-to-left direction.

Still further, in order to easily perform the rotation operation of the hedge trimmer 10 around the main handle 13 as the rotation axis as described above, it is more advantageous to connect the main handle 13 at a position between the heavy main body front portion 121 and the main body rear portion 122 on which the battery pack 15 is mounted, the position being in the vicinity of the center in the up-to-down direction in FIG. 4A, because of capable of reducing the inertia moment upon the rotation operation. Therefore, the main handle 13 is set lower than the top portion X of the main body front portion 121 and the top portion Y of the main body rear portion 122. However, even when the main handle 13 is connected at the position between the heavy main body front portion 121 and the main body rear portion 122 in the vicinity of the center in the up-to-down direction, the hand griping the main handle 13 interferes with the main body front portion 121 and the main body rear portion 122 in some cases as similar to the above description in the case of the large-capacity and large-size battery pack 15. In order to suppress this, the main body front sloped portion 124 and the main body rear sloped portion 125 are provided. That is, by providing the main body front sloped portion 124 and the main body rear sloped portion 125, the rotation operation becomes particularly easy.

Still further, by mounting the speed change switch 126 on the main body front sloped portion 124, the worker can easily operate the speed change switch 126 with, for example, his/her thumb while gripping the main handle 13. That is, the movement speed of the cutting blade 11 can be easily changed. Here, while the speed change switch 126 can be mounted on the main body rear sloped portion 125. However, in order to allow the worker to easily operate the speed change switch 126 while holding the hedge trimmer 10, it is preferred to mount the speed change switch 126 on the main body front sloped portion 124 which is close to the center of gravity of the hedge trimmer 10.

By setting the main switch 127 so as to turn around the pivot axis O on the rear side, no level difference is formed on the surface of the main handle 13 on the rear side in both of the on-state and the off-state of the main switch 127 (FIGS. 8A and 8B). Therefore, in both of the on-state and the off-state of the main switch 127, the worker can easily grip the main handle 13. As illustrated in FIGS. 8A and 8B, the level difference caused by the main switch 127 is formed only on the front side of the main handle 13 in the off-state (FIG. 8A) whereas this level difference is cleared in the on-state (FIG. 8B). The rotation operation of the hedge trimmer 10 around the main handle 13 as the rotation axis while keeping the hedge trimmer 10 in the operation becomes easier. Still further, in order to mount the main switch 127 on the front side of the main handle 13 as described above, the configuration in which the main handle 13 is thicker toward the front side is preferable as described above.

In this manner, by using a combination of the main body 12, the main handle 13, and the battery pack 15 in the above-described configuration, the rotation of the hedge trimmer 10 around the main handle 13 as the rotation axis can be easily performed without requiring the strong arm force. Still further, the worker can easily hold the hedge trimmer 10 regardless of the positional relation between the worker and the hedge trimmer 10.

A case that the above-described effects are remarkable is, for example, the case of the battery pack 15 with the large capacity and the large size for lengthening the continuous usage time. Therefore, the above-described effects are remarkable in the case that the nominal voltage of the battery pack 15 as the rated specification is equal to or larger than 20 V. In accordance with this, it is most effective that the outer diameter of the thinnest portion of the main handle 13 is about 94 mm to 157 mm.

Note that, in the above-described configuration, it is not required that the main handle 13 is formed in the exact linear shape, and it is not required that the cross-sectional shape is not formed in the exact circular shape. These shapes can be slightly-deformed linear shape and circular shape as long as the rotation operation of the hedge trimmer 10 around the main handle 13 as the rotation axis is easily performed.

(Sub-handle)

Hereinafter, a configuration of the sub-handle 14 of the hedge trimmer 10 will be described. This sub-handle 14 also has the configuration in which the hedge trimmer 10 can be easily rotated around the main handle 13 as the rotation axis. Also, the hedge trimmer 10 can be easily held with both hands regardless of the positional relation between the worker and the hedge trimmer 10.

As illustrated in FIGS. 1 to 3, each of both ends of the sub-handle 14 is fixed to a sub-handle fixing portion 129 of the main body front portion 121. Also, the sub-handle 14 is configured to have a reversed U shape which bridges the main body front portion 121 in perpendicular to the longitudinal direction of the cutting blade 11 so as to be gripped from above by the worker. In order to easily grip the sub-handle 14 from above by the worker, the sub-handle 14 has a symmetrical shape which extends obliquely forward and upward from the sub-handle fixing portion 129. In this manner, even when the top portion X of the main body front portion 121 is highly formed for embedding the large motor 17 therein, a sufficiently-large space is formed between the upper portion of the sub-handle 14 and the main body front portion 121.

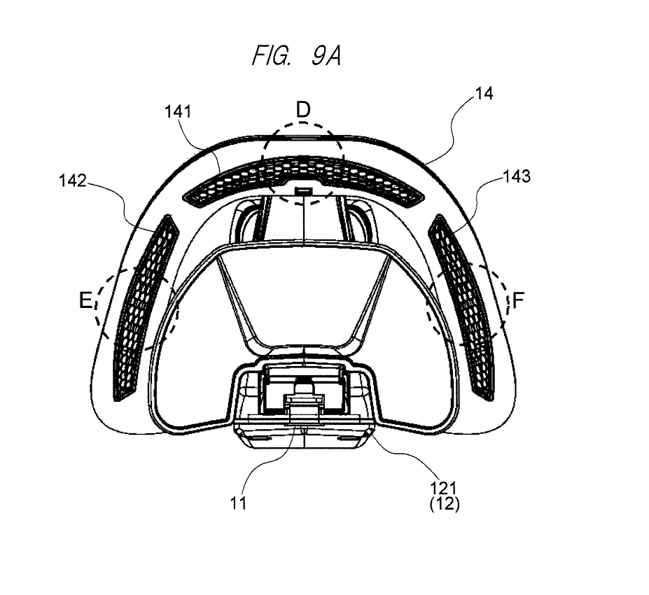

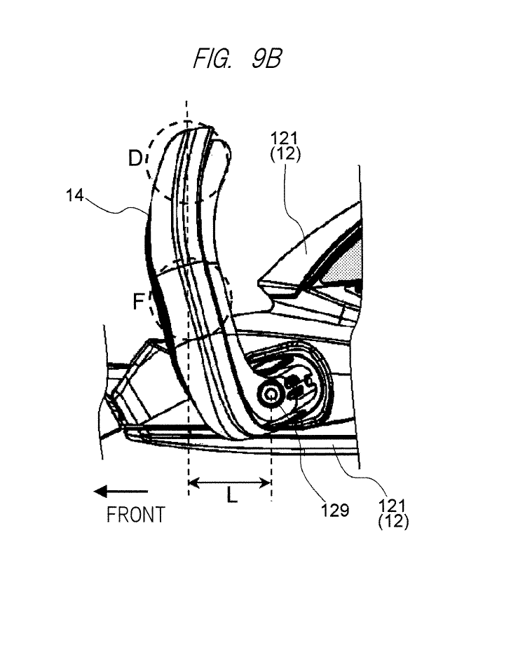

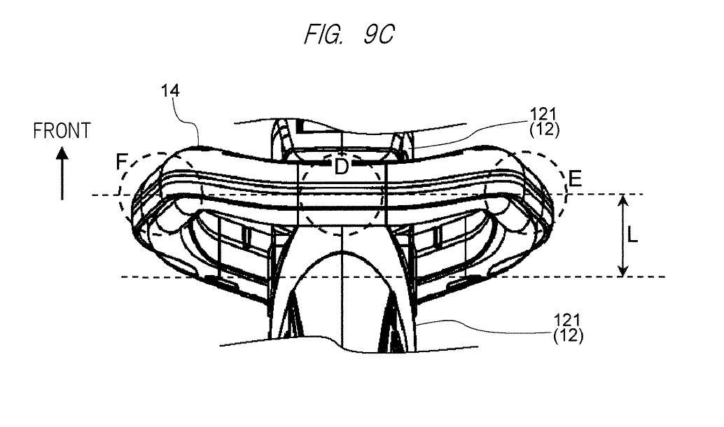

In FIGS. 9A to 9C, FIG. 9A is a front view of the hedge trimmer 10, viewed in the direction of extension of the cutting blade 11, FIG. 9B is an enlarged side view of the periphery of the sub-handle 14, and FIG. 9C is a top view of the same. These drawings illustrate three-dimensional shapes of the sub-handle 14 and the periphery thereof.

In this sub-handle 14, three areas (D, E, and F) surrounded by broken lines in FIGS. 9A to 9C are set as portions for gripping the sub-handle 14 by the worker. The area D (one portion) is a top portion of the sub-handle 14, and is used as an area of the sub-handle 14 to be gripped in the usage state of FIG. 10A while holding the hedge trimmer 10 from the upper side in FIG. 1. The areas E and F (two portions) are provided on both sides of the sub-handle 14 in the right-to-left direction, and are used as areas of the sub-handle 14 to be gripped when the hedge trimmer 10 is rotated by 90 degrees from the state of FIG. 10A.

As illustrated in FIGS. 9B and 9C, all distances in the longitudinal direction between the sub-handle fixing portion 129 and the areas D, E, and F are equally “L”. As described above, the sub-handle 14 has the symmetrical shape which extends obliquely forward and upward from the sub-handle fixing portion 129, and has a bent shape so that the areas D, E, and F are positioned on the shape.

Also, as illustrated in FIG. 9A, antislip areas (areas subjected to an antislip treatment) 141, 142, and 143 are partially formed on the front side of the surface of the sub-handle 14. The antislip areas 141 to 143 are formed by, for example, forming an elastomer (an elastic resin material) on the surface of the sub-handle 14 made of plastic. The antislip areas 141, 142, and 143 are formed so as to a part of each of the areas D, E, and F, respectively. Also, the antislip areas 141, 142, and 143 are formed as independent patterns from each other, that is, as being separated from each other, and there is an area not subjected to the antislip treatment between the area 141 and the area 142 and between the area 141 and the area 143. Further, the antislip areas 141 to 143 are formed only on the front side of the sub-handle 14, and are not formed on the side and rear side of the sub-handle 14.

According to the sub-handle 14 having the above-described configuration, the worker can easily perform the rotation operation of the whole hedge trimmer 10 around the main handle 13 as the rotation axis as similar to the case of using the above-described main handle 13. This point will be explained below.

Among the components for forming the hedge trimmer 10 such as the cutting blade 11, the main body front portion 121, and the main body rear portion 122, the main body front portion 121 in which the heavy motor 17 and others are embedded is the heaviest. Also, as clearly seen from FIG. 1 and others, the main body front portion 121 is positioned at a portion close to the center of the hedge trimmer 10 in the longitudinal direction, and therefore, the position of the center of gravity of the hedge trimmer 10 in the longitudinal direction is in the vicinity of the main body front portion 121. Therefore, by gripping the sub-handle 14 fixed to the main body front portion 121 from above in the vertical direction, the hedge trimmer 10 can be held to be balanced.

As described above, when the worker holds the hedge trimmer 10, the worker grips the sub-handle 14 with one hand and the main handle 13 with the other hand. In this state, when the rotation operation of the hedge trimmer 10 around the main handle 13 as the rotation axis is performed, it is preferred to slide the one hand along the surface of the sub-handle 14 while gripping the main handle 13 with the other hand so that the one hand is moved to the portion of the sub-handle 14 to be gripped for reducing physical load of the worker and efficiently performing the trimming work.

At this time, when the hedge trimmer 10 is used in the state of FIG. 10A, it is preferred that the worker grips the area D which is the top of the sub-handle 14 with the one hand. Then, when the hedge trimmer 10 in the state is rotated by 90 degrees and is used in the state of FIG. 10B, it is preferred that the worker grips the area E or F which is the top of the sub-handle 14 in this state with the one hand. Therefore, the worker moves the one hand from the area D to the area E or F in performing the rotation.

At this time, if distances between the center of gravity of the hedge trimmer 10 and the portions (the area D, E, and F) of the sub-handle 14 to be gripped with the one hand significantly change, weight balance significantly changes. Therefore, the phenomena that the worker suddenly feels the hedge trimmer 10 getting heavier maybe caused at a moment of, for example, the rotation of the hedge trimmer 10 by 90 degrees. When such phenomena cause, it is obviously difficult to perform the rotation operation of the hedge trimmer 10 while performing the trimming work by the worker. Particularly when, for example, the worker holds the hedge trimmer 10 at the position higher than the worker's shoulder, it is obviously difficult to hold the hedge trimmer 10 if such a sudden change in the weight balance causes.

In the above-described sub-handle 14, the distances in the longitudinal direction between the sub-handle fixing portion 129 and the areas D, E, and F are equalized to each other (see the distance L in FIGS. 9A to 9C). By this configuration, the distances in the longitudinal direction between the center of gravity of the hedge trimmer 10 and the areas D, E, and F are also almost equalized. In this manner, at least when the worker grips the area D, E, and/or F, the weight balance does not change. Therefore, the rotation operation of the hedge trimmer 10 can be further easily performed. Particularly, the rotation operation of the hedge trimmer 10 while performing the trimming work by the worker can be easily performed regardless of the positional relation between the worker and the hedge trimmer 10.

Also, at this time, in order to allow the worker to firmly grip the sub-handle 14, it is preferred that the antislip treatment is subjected to the surface of the sub-handle 14. On the other hand, when the hedge trimmer 10 is rotated, the one hand is slid and moved over the surface of the sub-handle 14. From this viewpoint, it is preferred that the antislip treatment is not subjected to the surface of the sub-handle 14. Therefore, in the above-described configuration, only the antislip areas 141 to 143 including the respective areas D, E, and F to be firmly griped are locally subjected to the antislip treatment whereas the areas not subjected to the antislip treatment are also formed. More particularly, the area between the antislip area 141 and the antislip area 142 and the area between the antislip area 141 and the antislip area 143 are not subjected to the antislip treatment, and therefore, the movement operation of the one hand from the area D to the area E or from the area D to the area F can be easily performed, and besides, the sub-handle 14 can be firmly gripped in each of the areas D, E, and F.

Similarly, the antislip areas 141 to 143 are formed only on the front side of the sub-handle 14 but are not formed on other sides thereof. Therefore, the worker can easily set either the firm gripping of the sub-handle 14 with the one hand or the sliding of the one hand over the surface of the sub-handle 14 by adjusting application of force to each finger of the one hand while gripping each of the areas D, E, and F.

Therefore, by forming the antislip areas 141 to 143 having the above-described configuration, the rotation operation of the whole hedge trimmer 10 around the main handle 13 as the rotation axis by the worker can be particularly easily performed.

Note that the elastomer can be formed on the surface of the sub-handle 14 as the antislip treatment as described above. However, a different processing treatment can be performed as long as the antislip processing can be locally treated.

Also, as the shape of the sub-handle 14 and the shapes of the antislip areas 141 to 143, not only the shapes illustrated in FIG. 9 but also different shapes can be used as long as the same effect is exerted.

As described above, the rotation operation of the hedge trimmer 10 can be particularly performed by, for example, the configuration of the main handle 13 and the periphery thereof and the configuration of the sub-handle 14 and the periphery thereof in the above-described configuration. Note that it is obvious to obtain such an effect even when only either the configuration of the main handle 13 and the periphery thereof or the configuration of the sub-handle 14 and the periphery thereof is used. Nevertheless, it is the most preferred to combine the main handle 13 and the sub-handle 14 in the above-described configuration.

What is claimed is:

1. A hedge trimmer comprising:
a main body in which a motor is embedded;
a cutting blade which is reciprocated by the motor in a longitudinal direction so as to protrude from a front end of the main body;
a battery pack which is mounted on the main body and which is functioned as a power supply for driving the motor;
a sub-handle which has a reversed U shape so as to bridge over the main body in perpendicular to the longitudinal direction of the cutting blade and whose both ends are connected to the main body; and
a main handle which is connected to the main body on the side closer to a rear end of the main body than the sub-handle so as to extend to form a grip space in the longitudinal direction between the main handle and the main body,
the main body being formed of: a main body front portion which is configured to include the front end and to which the sub-handle is connected; a main body rear portion which is configured to include the rear end and on which the battery pack is mounted; and a supporting portion which connects the main body front portion and the main body rear portion on a lower side,
a center axis of the main handle being formed in a straight line shape in parallel to the longitudinal direction, and one end and the other end of the main handle are connected to a rear end side of the main body front portion and a front end side of the main body rear portion, respectively, so that the grip space is formed between the main handle and the supporting portion, and
the battery pack being mounted on the rear end side of the main body rear portion.

2. The hedge trimmer according to claim 1,
wherein a cross-sectional surface of the main handle perpendicular to the longitudinal direction is substantially circular.

3. The hedge trimmer according to claim 1,
wherein a top portion of the main body front portion and a top portion of the main body rear portion are set higher than the main handle.

4. The hedge trimmer according to claim 3,
wherein an upper surface between the top portion of the main body front portion and one end of the main handle and an upper surface between the top portion of the main body rear portion and the other end of the main handle are formed in a sloped shape whose height gradually changes.

5. The hedge trimmer according to claim 4,
wherein a speed change switch for controlling a speed of the reciprocation movement of the cutting blade is mounted on the upper surface between the top portion of the main body front portion and the one end of the main handle.

6. The hedge trimmer according to claim 1,
wherein an outer diameter of a cross-sectional surface of the main handle in perpendicular to the longitudinal direction is narrowed gradually from the one end toward the other end.

7. The hedge trimmer according to claim 1,
wherein a main switch to be pressed toward the center axis side of the main handle for turning on the motor is mounted on a surface of the main handle on a side where the grip space is formed, and,
when the motor is turned on, a level difference is not formed between a surface of the main switch and a surface of the main handle in periphery of the surface of the main switch.

8. The hedge trimmer according to claim 7,
wherein the main switch is rotated around a pivot axis set on a portion of the main switch on the other end side of the main handle so that the motor is turned on.

9. The hedge trimmer according to claim 1,
wherein the battery pack is mounted on a battery pack mounting surface formed on the main body rear portion at an angle tilted from an angle perpendicular to the center axis of the main handle toward the rear end side.

10. The hedge trimmer according to claim 1,
wherein the sub-handle extends obliquely forward and upward from a portion connected to the main body front portion, and the sub-handle has a bent shape so that each distance along the longitudinal direction from a portion of the sub-handle connected to the main body front portion to each of two portions of the sub-handle on both sides in a right-to-left direction perpendicular to both of an up-to-down direction and the longitudinal direction and one portion thereof on an upper side is substantially equalized.

11. The hedge trimmer according to claim 1,
wherein an area subjected to an antislip treatment and an area not subject to the antislip treatment in the sub-handle are partially formed on a surface of an area of the sub-handle to be gripped by a worker.

12. The hedge trimmer according to claim 11,
wherein the area subjected to the antislip treatment in the sub-handle is separately formed on each of three areas including the two portions of the sub-handle on both sides in the right-to-left direction perpendicular to both of the up-to-down direction and the longitudinal direction and the one portion thereof on the upper side.

13. The hedge trimmer according to claim 11,
wherein, in the area subject to the antislip treatment, an elastomer is formed on a surface of the sub-handle.

14. A hedge trimmer comprising:
a main body in which a motor is embedded;
a cutting blade which is reciprocated by the motor in a longitudinal direction so as to protrude from a front end of the main body;
a main handle which is connected to the main body and which includes a switch; and
a battery pack which is mounted on a main body rear portion closer to a rear side than the main handle and which is functioned as a power supply for driving the motor,
a nominal voltage of the battery pack being equal to or higher than 20 V,
a peripheral length of the main handle being equal to or smaller than 157 mm, and
a main body front portion closer to a front side than the main handle being connected to the main body rear portion by a supporting portion extending in substantially parallel to the main handle.
